(19) United States
(12) Patent Application Publication
(10) Pub. No.: US 2025/0193963 A1
(43) Pub. Date: Jun. 12, 2025

(54) CONFIGURING READER DEVICES ASSOCIATED WITH AMBIENT INTERNET OF THINGS (AIOT) DEVICES

(71) Applicant: Lenovo (United States) Inc., Morrisville, NC (US)

(72) Inventor: Hyung-Nam CHOI, Ottobrunn (DE)

(21) Appl. No.: 19/060,503

(22) Filed: Feb. 21, 2025

(51) Int. Cl. H04W 76/27; H04L 5/00; H04W 72/40

(52) U.S. Cl. CPC H04W 76/27; H04L 5/0048; H04W 72/40

(57) ABSTRACT

Various aspects of the present disclosure relate to a user equipment (UE), operating as a reader device for one or more ambient Internet of Things (AIoT) devices, transmitting assistance information to a base station. The base station, using the assistance information, may configure, or reconfigure the UE, to optimally perform AIoT reader operations for the AIoT devices, such as command procedures and/or inventory procedures.

### TECHNICAL FIELD

The present disclosure relates to wireless communications, and more specifically to configuring reader devices associated with ambient Internet of Things (AIoT) devices.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Ambient power-enabled devices, such as ambient Internet of Things (IoT) devices, or AIoT devices, include battery-less devices that have limited storage capabilities (e.g., store a limited amount of energy using capacitors) or other capability restrictions. These ambient power-enabled devices may store energy by harvesting energy from the environment of the devices, such as via radio waves, light, heat, motion, and other energy/power sources available to the devices.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that configure reader devices associated with AIoT devices. For example, the present disclosure facilitates the provisioning of assistance information to a base station to assist the base station in reconfiguring a UE to optimally perform AIoT reader operations for one or more associated AIoT devices.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity, a first message comprising a configuration that identifies one or more preferences associated with operation of the UE as a reader device and transmit, to the network entity, a second message comprising one or more parameters associated with the identified one or more preferences.

A processor for wireless communication is described. The processor may be configured to, capable of, or operable to perform one or more operations as described herein. For example, the UE may comprise at least one controller and at least one memory coupled with the at least one controller and configured to cause the processor to receive, from a network entity, a first message comprising a configuration that identifies one or more preferences associated with operation of the UE as a reader device and transmit, to the network entity, a second message comprising one or more parameters associated with the identified one or more preferences.

A method performed or performable by the UE is described. The method may comprise receiving, from a network entity, a first message comprising a configuration that identifies one or more preferences associated with operation of the UE as a reader device and transmitting, to the network entity, a second message comprising one or more parameters associated with the identified one or more preferences.

In some implementations of the UE, processor, and method described herein, the one or more parameters include: radio resource control (RRC) connected state parameters, RRC state information for the operation of the UE as the reader device, a mode of operation for the UE as the reader device, a number of downlink (DL) radio frequency (RF) channels, a number of uplink (UL) RF channels, a list of neighboring reader devices, or combinations thereof.

In some implementations of the UE, processor, and method described herein, the UE, processor, and method may further be configured to, capable of, performed, performable, or operable to receive the first message in an RRC connected state.

In some implementations of the UE, processor, and method described herein, the UE, processor, and method may further be configured to, capable of, performed, performable, or operable to transmit the second message in an RRC connected state.

In some implementations of the UE, processor, and method described herein, the second message is an assistance information message.

In some implementations of the UE, processor, and method described herein, the one or more preferences include release preferences for the UE, and wherein the second message includes a parameter that indicates an RRC state of operation of the UE.

In some implementations of the UE, processor, and method described herein, the UE, processor, and method may further be configured to, capable of, performed, performable, or operable to receive, from the network entity, a third message that includes an RRC release command and modify a current operation from an RRC connected state to an RRC idle state or an RRC inactive state.

In some implementations of the UE, processor, and method described herein, the one or more preferences include configuration preferences for the reader device, and wherein the second message includes a parameter that indicates a number of UL RF channels, a number of DL RF channels, or a combination thereof.

In some implementations of the UE, processor, and method described herein, the UE, processor, and method may further be configured to, capable of, performed, performable, or operable to receive, from the network entity, a third message that includes a reconfiguration command and perform a reconfiguration of the UE using the indicated number of UL RF channels, DL RF channels, or combinations thereof.

A network entity for wireless communication is described. The network entity may be configured to, capable of, or operable to perform one or more operations as described herein. For example, the network entity may comprise at least one memory and at least one processor coupled with the at least one memory and configured to cause the network entity to transmit, to a reader device, a first message comprising a configuration that identifies one or more preferences associated with operation of the reader device and receive, from the reader device, a second message comprising one or more parameters associated with the identified one or more preferences.

A method performed or performable by the network entity is described. The method may comprise transmitting, to a reader device, a first message comprising a configuration that identifies one or more preferences associated with operation of the reader device and receiving, from the reader device, a second message comprising one or more parameters associated with the identified one or more preferences.

In some implementations of the network entity and method described herein, the network entity and method may further be configured to, capable of, performed, performable, or operable to transmit, to the reader device, a third message that comprises a command to adjust the one or more parameters associated with the one or more preferences.

In some implementations of the network entity and method described herein, the one or more parameters comprise RRC connected state parameters, RRC state information for the operation of the reader device, a mode of operation for the reader device, a number of DL RF channels, a number of UL RF channels, or combinations thereof.

### BRIEF DESCRIPTION OF THE DRAWINGS

FIG. 1 illustrates an example of a wireless communications system in accordance with aspects of the present disclosure.

FIGS. 2A-2B illustrate example topologies for AIoT devices in accordance with aspects of the present disclosure.

FIG. 3 illustrates an example deployment scenario for a reader device and associated AIoT devices in accordance with aspects of the present disclosure.

FIG. 4 illustrates a messaging flow between a UE and a base station in accordance with aspects of the present disclosure.

FIG. 5 illustrates another messaging flow between a UE and a base station in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of a network equipment (NE) in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

A wireless communications system may include one or more IoT devices, which may be an AIoT device, a passive-IoT device, and/or a passive radio frequency identification (RFID) tag (e.g., sticker, tag, badge, patch, or the like) that supports one or more functionalities at lower cost and maintenance compared to other devices. For example, an AIoT device may harvest and store energy from an environment, such as one or more of solar (e.g., via photovoltaic energy harvesting), vibration (e.g., via piezoelectric, electrostatic, or electromagnetic energy harvesting), thermal (e.g., via thermoelectric energy harvesting), or radio waves, such as radio frequency (e.g., via signals received through an antenna of the AIoT device). The AIoT device may perform one or more operations (e.g., transmission, reception, via backscattering) using the stored harvested energy. For example, the AIoT device may be a passive RFID tag equipped on an object or other device enabling for tracking of a location of the object or the other device using stored harvested energy. Example use cases for AIoT devices include inventory taking, sensor data collection, asset tracking, actuator control, and so on.

An AIoT device may be classified according to one or more categories. A first category AIoT device may lack both energy harvesting capabilities and communication capabilities. As such, the first category AIoT device may be exclusively capable of performing backscattering operations (e.g., backscattering transmissions). A second category AIoT device may support energy harvesting capabilities but lack communication capabilities. As such, the second category AIoT device may be exclusively capable of performing backscattering operations (e.g., backscattering transmissions). However, in some cases, because the second category AIoT device supports energy harvesting capabilities, the second category AIoT device may be capable of amplifying reflected signals using stored harvested energy. A third category AIoT device may support both energy harvesting and communication capabilities. In this example, the third category AIoT device may be equipped with an active radio frequency circuitry to support active communication (e.g., transmission, reception of signals).

A UE or a base station (or other network equipment) may interact with an AIoT device operating as a reader device. For example, a reader device may transmit a carrier wave to the AIoT device to excite the AIoT device to perform backscattering transmissions or other communications or may simply read or receive the backscattering transmissions. However, issues can arise when utilizing or configuring a UE as a reader device. For example, configuring a UE as a reader device may introduce complexity that can impact its power consumption and/or operations (e.g., operations on a 5G, or NR, network).

To overcome such issues, the technology described herein optimizes or enhances the UE as a reader device (e.g., an AIoT reader). For example, a base station serving the UE may request assistance information from the UE, such as information that identifies one or more preferences (e.g., RRC state, number of RF channels, and so on) for AIoT reader operations. Using the assistance information, the base station may configure the UE as a reader device in an optimal, enhanced, or suitable manner. In doing so, the base station can support performance of the UE as a reader device while minimizing the impact to NR operations for the UE, among other benefits.

Aspects of the present disclosure are described in the context of a wireless communications system.

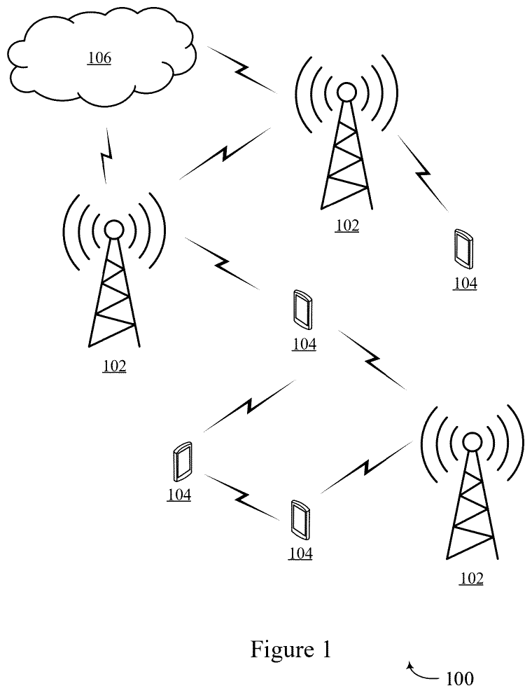

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support managing (e.g., controlling, configuring) operation of IoT devices (e.g., which may be an example of a UE 104), such as AIoT devices. As described herein, an AIoT device may be associated with a low complexity profile (e.g., low power consumption, less capabilities) and/or be implemented as an ambient-power enabled ultra-low complexity device with ultra-low power consumption.

In some embodiments, the wireless communications system 100 may implement various topologies and deployment scenarios, such as an example topology in which an NE (e.g., a base station or other network entity) functions as a reader (e.g., a reader device) and a source of a carrier wave (e.g., for exciting an AIoT device to perform backscattering), another example topology in which the NE functions as the reader and a different device (e.g., a UE) functions as the source of the carrier wave, another example topology in which the NE controls operations and the UE (e.g., the UE 104) or other network entities (e.g., nodes) function as readers and/or carrier wave sources, and the like.

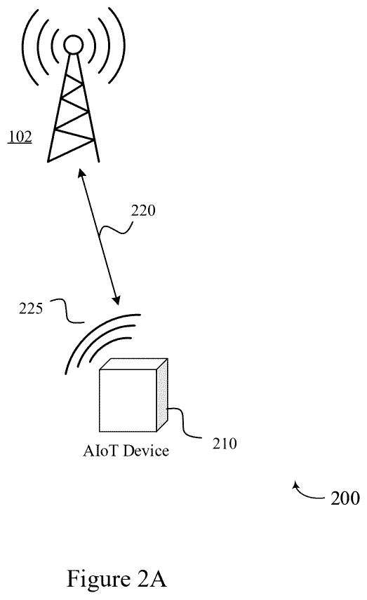

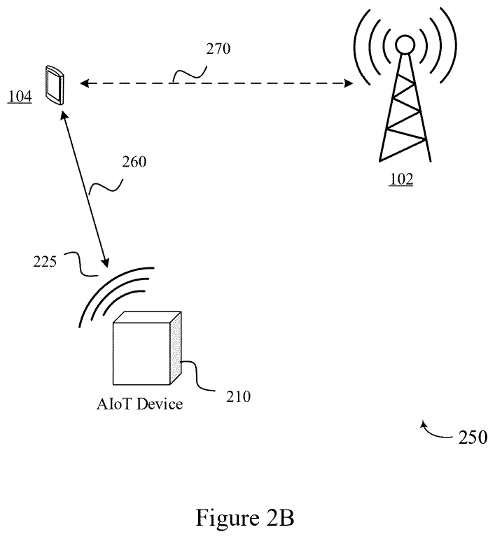

FIGS. 2A-2B illustrate example topologies for AIoT devices in accordance with aspects of the present disclosure. As shown in FIG. 2A, in a first topology 200, an AIoT device 210 directly and bidirectionally communicates with the NE 102 (e.g., which may serve a micro cell). A communication link 220 between the NE 102 and the AIoT device 210 may include AIoT data (e.g., via backscattering 225) and/or signaling. In an example implementation, both the AIoT device 210 and the NE 102 are located indoors (with the micro cell being part of a group of cells or NEs 102).

FIG. 2B illustrates a second topology 250, where the UE 104, or another node, acts as an intermediate node between the NE 102 and the AIoT device 210. For example, the UE 104 may function as an emitter and/or reader, where the UE 104 sends carrier waves to the AIoT device 210, which excite the AIoT device 210, enabling or causing the AIoT device 210 to performing the backscattering transmissions 225, which are read by the UE 104.

In the second topology 250, the AIoT device 210 directly and bidirectionally communicates with the UE 104 (e.g., which may relay data to the NE 102, serving a macro cell). A communication link 260 between the UE 104 and the AIoT device 210 and/or a link 270 between the UE 104 and the NE 102 may include AIoT data (e.g., via backscattering 225) and/or signaling. In an example implementation, the AIoT device 210 and the UE 104 are located indoors and the NE 102 is located outdoors (with the macro cell being part of a group of cells or NEs 102).

The AIoT device 210 may communicate with the intermediate node and/or the network (e.g., via the NE 102) using a reduced set of components. For example, the AIoT device 210 may be an IoT device of ultra-low complexity with ultra-low power consumption (e.g., sufficient for low-end IoT applications), having a radio protocol stack architecture that is comparatively compact with respect to typical NR architectures for communication devices.

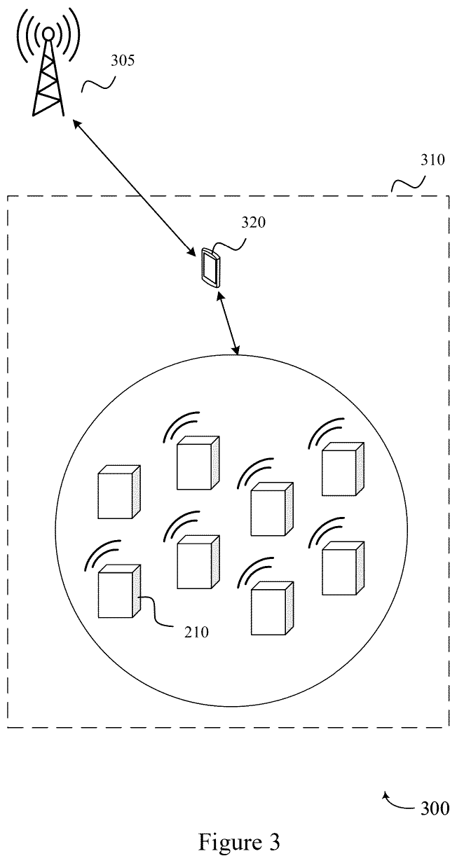

FIG. 3 illustrates an example deployment scenario 300 for a reader device and associated AIoT devices in accordance with aspects of the present disclosure. A location 310, or target area (e.g., a warehouse or other indoor facility), is served by a base station 305 in communication with (e.g., serving) a UE 320 deployed and/or positioned as a reader device with respect to various AIoT devices 210 (e.g., 100 or more AIoT devices). The UE 320 may be a stationary reader device (e.g., a device fixed or installed to one location within the location 310), a mobile reader device (e.g., a device that moves within the location 310), and so on.

Depending on the deployment scenario, the UE 320, the base station 305, and/or another external node may transmit carrier waves to cause the AIoT devices 210 to perform backscattering transmissions (e.g., read by the UE 320). In some cases, the UE 320 performs AIoT operations (e.g., reading backscattering transmissions) inband to the NR (e.g., inband to an NR frequency division duplexing (FDD) band, occupying a bandwidth of 1 MHz each in UL/DL.) For example, in each bandwidth part, a number of RF channels are defined for AIoT (e.g., where each RF channel has a size of 180 kHz).

As described herein, in order to optimize and/or enhance the operation of a UE (e.g., the UE 320) as an AIoT reader or reader device, the UE 320 may be configured by a base station (e.g., the base station 305) to provide assistance information to the base station. For example, the UE 320, when in an RRC_CONNECTED state, may transmit the assistance information via a UEAssistanceInformation message.

In some embodiments, the assistance information may include information about one or more preferences (e.g., preferences for AIoT reader operation) and/or one or more parameters associated with the preferences. The preferences may include:

A reader mode of operation—the UE 320 may provide a value or parameter, among various values or parameters (e.g., TX only, RX and TX, RX only), that identifies its preferred mode of operation during AIoT reader operation. For example, the parameter “RX and TX” indicates that the UE 320 prefers to be operated in a monostatic mode of operation, the parameter “TX only” indicates that the UE 320 prefers to transmit only reader to device (R2D) messages and carrier waves (in uplink) in a bistatic mode of operation, and the parameter “RX only” indicates that the UE 320 prefers to receive only backscattered device to reader (D2R) messages (e.g., from the AIoT devices 210) in a bistatic mode of operation;

A number of DL RF channels.—the UE 320 may provide a value or parameters that indicates a number K of DL RF channels (e.g., where K is 1, 2, 3, or 4) preferred to be used for AIoT reader operations;

A number of UL RF channels.—the UE 320 may provide a value or parameters that indicates a number K of UL RF channels (e.g., where K is 1, 2, 3, or 4) preferred to be used for AIoT reader operations;

A list of neighbor reader devices—the UE 320 may store or include a list of M neighbor reader devices, such as other UEs proximate to the UE 320. For example, the list may include or contain L entries of unique reader IDs (e.g., UE IDs for the neighbor reader devices). The value or parameter M may be 1, 2, 4, 8, and so on. In some cases, the UE 320 may identify and/or determines neighbor reader devices via an SL discovery procedure (e.g., to identify candidate UEs) and/or may be configured with information about the neighbor reader devices, such as layout information for the location 310; and other preferences.

The base station 305, upon receiving assistance information from the UE 320, may adjust connected or operation mode parameters (e.g., discontinuous (DRX) or other power-saving parameters, maximum aggregated bandwidth, number of MIMO layers, and so on), parameters for transferring the UE 320 to a certain RRC state (e.g., RRC_IDLE, RRC_INACTIVE state, RRC_CONNECTED state), reconfigure the number of UL/DL RF channels for AIoT reader operation, change the mode of AIoT reader operation, configure other UEs as the AIoT reader, and so on. Thus, the base station 305 (e.g., a gNB) can configure the UE 320 for optimal, enhanced, or efficient operation during NR and/or AIoT reader operations, among other benefits.

As described herein, the technology, in some embodiments, may be implemented as one or more messaging flows between a base station (e.g., the base station 205 or another network node) and a UE (e.g., the UE 320 or another reader device).

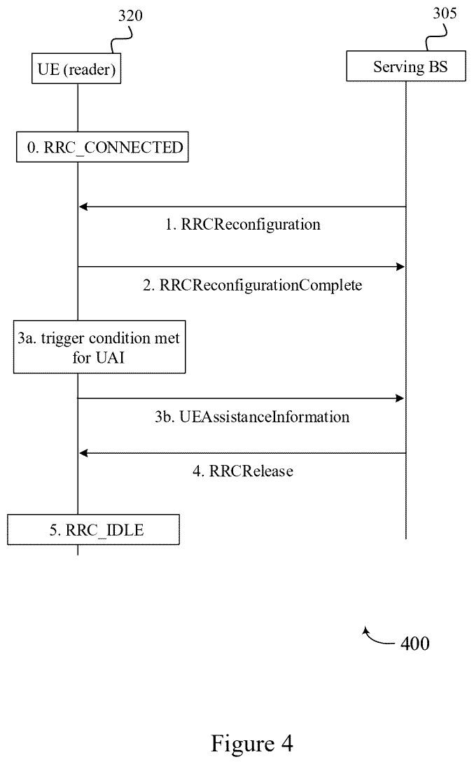

FIG. 4 illustrates a messaging flow 400 between a UE and a base station in accordance with aspects of the present disclosure. The messaging flow 400 may implement various aspects of the present disclosure described herein. For example, the messaging flow 400 may include the base station 305 and the UE 320, which may be examples of UEs and base stations (e.g., the NE 102) as described herein. In the following description of the messaging flow 400, the operations between the base station 305 and the UE 320 may be performed in different orders or at different times. Some operations may also be omitted, or other operations may be added. Although the base station 305 and the UE 320 are shown performing the operations of the messaging flow 400, some aspects of some operations may also be performed by other entities of the messaging flow 400 or by entities that are not shown in the messaging flow 400, or any combination thereof

In step 0, the UE 320 operates in an RRC_CONNECTED state (e.g., within an NR cell served by the base station 305.

In step 1, the base station 305 transmits an RRCReconfiguration message to the UE 320. For example, the UE 320 is selected by the base station 305 to perform a command procedure (e.g., a read and/or write procedure) for AIoT devices (e.g., the AIoT devices 210). The base station 305 sends the RRCReconfiguration message to configure the UE 320 for AIoT operations.

In some cases, the UE 320 is configured to perform a monostatic mode of operation, with 1 DL RF channel and 2 UL RF channels. In order to configure the UE 320 to perform AIoT operations while being served in NR, the RRCReconfiguration message configures the UE 320 to transmit assistance information. For example, the UE 320 is configured to provide release preferences for power saving (e.g., by configuring the parameter “releasePreferenceConfig” in an OtherConfig information element (IE)) and preferences for AIoT reader operation (e.g., by configuring the parameter “aiot-ReaderOperationPreferenceConfig” in the OtherConfig IE).

In step 2, the UE 320 transmits a RRCReconfigurationComplete message to the base station 305. For example, the UE 320 transmits a message to confirm a successful reception of the RRCReconfiguration message from the base station 305.

In step 3a, a trigger condition is met for UE assistance information (UAI). For example, during start of a command procedure associated with the AIoT devices 210, the battery level of the UE 320 falls below a certain threshold (e.g., a threshold of 30% full), which acts as a trigger (e.g., for power saving) for the UE 320 to send the assistance information to the base station 305.

In step 3b, the UE 320 transmits a UEAssistanceInformation message to the base station 305. The message may include preference information (and associated parameters). For example, the UEAssistanceInformation message may include the following preference information: “preferred RRC state set to a value/parameter “idle” to continue the command procedure in RRC_IDLE state.”

As described herein, in order to optimize a user experience and to assist the base station 305 in configuring the UE 320 for optimized operations, the UE 320 may be configured to signal, through the UEAssistanceInformation message, its preferences, including preferences for AIoT reader operations. For example, the UE 320 may utilize various types of UAI, such as drx-Preference information (e.g., indicating the UE's on DRX parameters for power saving (preferredDRX-InactivityTimer, preferredDRX-LongCycle, preferredDRX-ShortCycle, preferredDRX-ShortCycleTimer)), releasePreference information (e.g., indicating the UE's preference on the RRC state for power saving), and others.

In step 4, the base station 305 transmits an RRCRelease message. For example, in response to receiving the UEAssistanceInformation message from the UE 320, the base station 305 determines to follow the requested preference for the UE 320 and sends the RRCRelease message (e.g., to transfer, or cause to transfer, the UE 320 from the RRC_CONNECTED state to an RRC_IDLE or RRC_INACTIVE state).

In step 5, the UE 320 is in the RRC_IDLE state. The UE 320 may continue performance of the command procedure (e.g., reading inventory information from the AIoT devices 210) associated with the AIoT devices 210 in its preferred and/or requested RRC state.

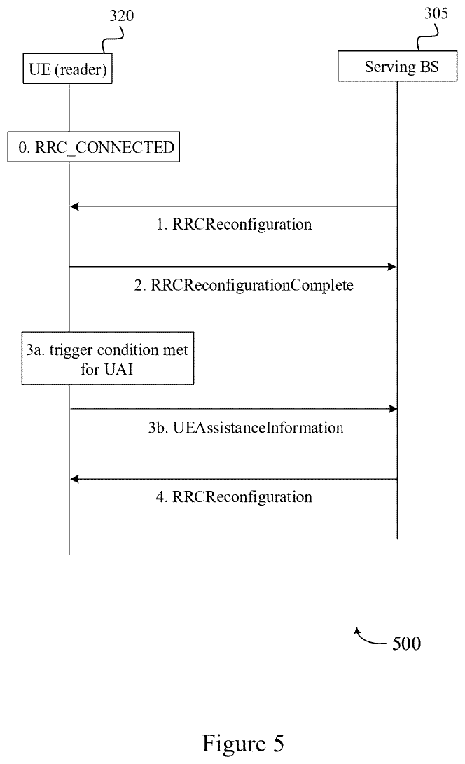

FIG. 5 illustrates another messaging flow 500 between a UE and a base station in accordance with aspects of the present disclosure. The messaging flow 500 may implement various aspects of the present disclosure described herein. For example, the messaging flow 500 may include the base station 305 and the UE 320, which may be examples of UEs and base stations (e.g., the NE 102) as described herein. In the following description of the messaging flow 500, the operations between the base station 305 and the UE 320 may be performed in different orders or at different times. Some operations may also be omitted, or other operations may be added. Although the base station 305 and the UE 320 are shown performing the operations of the messaging flow 500, some aspects of some operations may also be performed by other entities of the messaging flow 500 or by entities that are not shown in the messaging flow 500, or any combination thereof.

In step 0, the UE 320 operates in an RRC_CONNECTED state (e.g., within an NR cell served by the base station 305.

Similar to the messaging flow 400 of FIG. 4, in step 1, the base station 305 transmits an RRCReconfiguration message to the UE 320. For example, the UE 320 is selected by the base station 305 to perform a command procedure (e.g., a read and/or write procedure) for AIoT devices (e.g., the AIoT devices 210). The base station 305 sends the RRCReconfiguration message to configure the UE 320 for AIoT operations. In step 2, the UE 320 transmits a RRCReconfigurationComplete message to the base station 305. For example, the UE 320 transmits a message to confirm a successful reception of the RRCReconfiguration message from the base station 305.

In step 3a, a trigger condition is met for UAI. For example, during start of a command procedure associated with the AIoT devices 210, the UE 320 experiences poor performance of the contention-based random access procedure due to a high number of collisions.

In step 3b, the UE 320 transmits a UEAssistanceInformation message to the base station 305. For example, to improve the performance of the contention-based random access procedure and triggered by the UAI condition, the UE 320 transmits a UEAssistanceInformation message to include the following preference information: “number of UL RF channels set to value/parameter 4.”

In step 4, the base station 305 transmits an RRCReconfiguration message. For example, in response to receiving the UEAssistanceInformation message from the UE 320, the base station 305 determines to follow the requested preference for the UE 320 and sends the RRCReconfiguration message to increase, or cause to increase, the number of UL RF channels to 4 (e.g., for use during AIoT reader operations). The UE 320 continues the command or inventory procedure using the increased (e.g., from 2 to 4) and/or additional UL RF channels.

Thus, in various embodiments, the technology described herein enables a base station, serving a UE, to enhance the AIoT reader operations of the UE by reconfiguring the UE to optimally perform the AIoT reader operations when requested. The base station may receive and/or act upon assistance information, which facilitates the UE to send requests for preferences (and associated parameters) to be modified, updated, enhanced, or changed during certain AIoT reader operations, such as command procedures, inventory procedures, sensing procedures, tracking procedures, and so on.

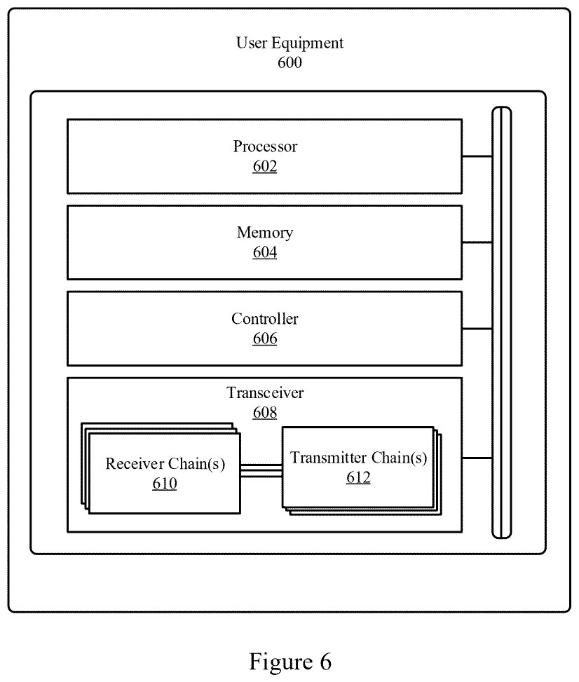

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to support a means for receiving, from a network entity, a first message comprising a configuration that identifies one or more preferences associated with operation of the UE as a reader device, and transmitting, to the network entity, a second message comprising one or more parameters associated with the identified one or more preferences.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

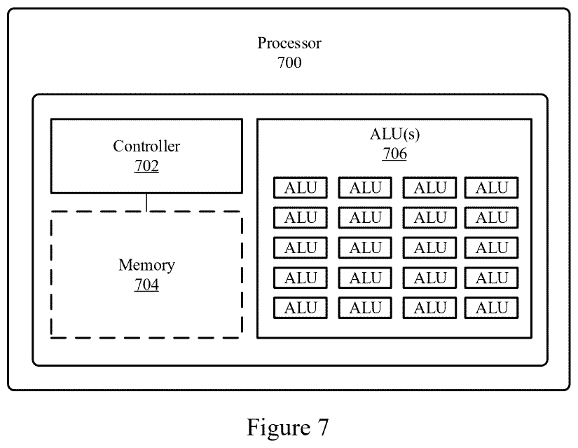

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The UE processor 700 may be configured to support a means for receiving, from a network entity, a first message comprising a configuration that identifies one or more preferences associated with operation of the UE as a reader device, and transmitting, to the network entity, a second message comprising one or more parameters associated with the identified one or more preferences.

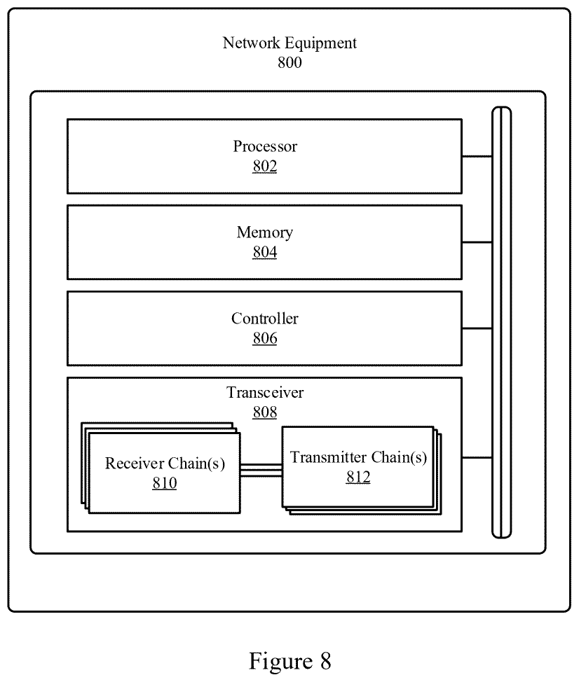

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to support a means for transmitting, to a reader device, a first message comprising a configuration that identifies one or more preferences associated with operation of the reader device and receiving, from the reader device, a second message comprising one or more parameters associated with the identified one or more preferences.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

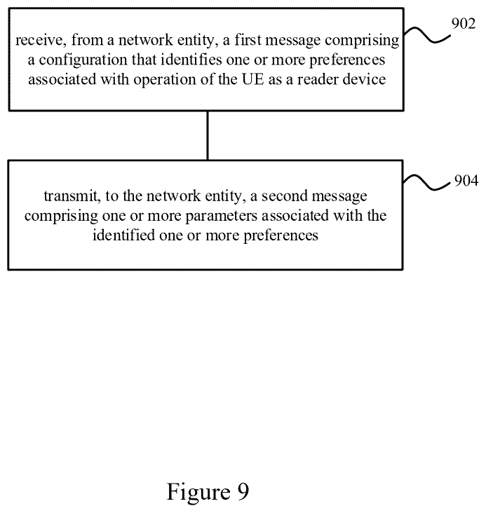

FIG. 9 illustrates a flowchart of a method in accordance with aspects of the present disclosure. The operations of the method may be implemented by a UE as described herein (e.g., such as a reader device). In some implementations, the UE may execute a set of instructions to control the function elements of the UE to perform the described functions.

At 902, the method may include receiving, from a network entity, a first message comprising a configuration that identifies one or more preferences associated with operation of the UE as a reader device. The operations of 902 may be performed in accordance with examples as described herein. In some implementations, aspects of the operations of 902 may be performed by a UE as described with reference to FIG. 6.

At 904, the method may include transmitting, to the network entity, a second message comprising one or more parameters associated with the identified one or more preferences. The operations of 904 may be performed in accordance with examples as described herein. In some implementations, aspects of the operations of 904 may be performed by a UE as described with reference to FIG. 6.

It should be noted that the method described herein describes a possible implementation, and that the operations and the steps may be rearranged or otherwise modified and that other implementations are possible.

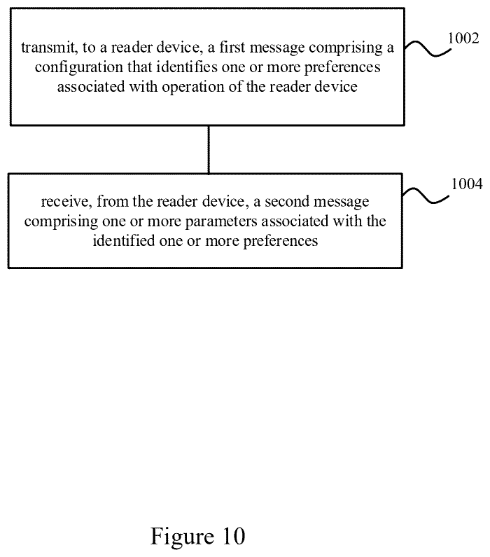

FIG. 10 illustrates a flowchart of a method in accordance with aspects of the present disclosure. The operations of the method may be implemented by an NE as described herein. In some implementations, the NE may execute a set of instructions to control the function elements of the NE to perform the described functions.

At 1002, the method may include transmitting, to a reader device, a first message comprising a configuration that identifies one or more preferences associated with operation of the reader device. The operations of 1002 may be performed in accordance with examples as described herein. In some implementations, aspects of the operations of 1002 may be performed by an NE as described with reference to FIG. 8.

At 1004, the method may include receiving, from the reader device, a second message comprising one or more parameters associated with the identified one or more preferences. The operations of 1004 may be performed in accordance with examples as described herein. In some implementations, aspects of the operations of 1004 may be performed by an NE as described with reference to FIG. 8.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, from a network entity, a first message comprising a configuration that identifies one or more preferences associated with operation of the UE as a reader device; and
transmit, to the network entity, a second message comprising one or more parameters associated with the identified one or more preferences.

2. The UE of claim 1, wherein the one or more parameters include:
radio resource control (RRC) connected state parameters;
RRC state information for the operation of the UE as the reader device;
a mode of operation for the UE as the reader device;
a number of downlink (DL) radio frequency (RF) channels;
a number of uplink (UL) RF channels;
a list of neighboring reader devices; or
combinations thereof.

3. The UE of claim 1, wherein the at least one processor is configured to cause the UE to receive the first message in a radio resource control (RRC) connected state.

4. The UE of claim 1, wherein the at least one processor is configured to cause the UE to transmit the second message in a radio resource control (RRC) connected state.

5. The UE of claim 1, wherein the second message is an assistance information message.

6. The UE of claim 1, wherein the one or more preferences include release preferences for the UE, and wherein the second message includes a parameter that indicates a radio resource control (RRC) state of operation of the UE.

7. The UE of claim 6, wherein the at least one processor is configured to cause the UE to:
receive, from the network entity, a third message that includes an RRC release command; and
modify a current operation from an RRC connected state to an RRC idle state or an RRC inactive state.

8. The UE of claim 1, wherein the one or more preferences include configuration preferences for the reader device, and wherein the second message includes a parameter that indicates:
a number of uplink (UL) radio frequency (RF) channels;
a number of downlink (DL) radio frequency (RF) channels; or
a combination thereof.

9. The UE of claim 8, wherein the at least one processor is configured to cause the UE to:
receive, from the network entity, a third message that includes a reconfiguration command; and
perform a reconfiguration of the UE using the indicated number of UL RF channels, DL RF channels, or combinations thereof.

10. A network entity for wireless communication, comprising:
at least one memory; and
at least one processor coupled with the at least one memory and configured to cause the network entity to:
transmit, to a reader device, a first message comprising a configuration that identifies one or more preferences associated with operation of the reader device; and
receive, from the reader device, a second message comprising one or more parameters associated with the identified one or more preferences.

11. The network entity of claim 10, wherein the at least one processor is further configured to cause the network entity to:
transmit, to the reader device, a third message that comprises a command to adjust the one or more parameters associated with the one or more preferences.

12. The network entity of claim 11, wherein the one or more parameters comprise:
radio resource control (RRC) connected state parameters;
RRC state information for the operation of the reader device;
a mode of operation for the reader device;
a number of downlink (DL) radio frequency (RF) channels;
a number of uplink (UL) RF channels; or
combinations thereof.

13. A method performed by a user equipment, the method comprising:
receiving, from a network entity, a first message comprising a configuration that identifies one or more preferences associated with operation of the UE as a reader device; and
transmit, to the network entity, a second message comprising one or more parameters associated with the identified one or more preferences.

14. The method of claim 13, wherein the one or more parameters include:
radio resource control (RRC) connected state parameters;
RRC state information for the operation of the UE as the reader device;
a mode of operation for the UE;
a number of downlink (DL) radio frequency (RF) channels;
a number of uplink (UL) RF channels;
a list of neighboring reader devices; or
combinations thereof.

15. The method of claim 13, wherein the first message is received in a radio resource control (RRC) connected state.

16. The method of claim 13, wherein the second message is transmitted in a radio resource control (RRC) connected state.

17. The method of claim 13, wherein the second message is an assistance information message.

18. The method of claim 13, further comprising:
receiving, from the network entity, a third message that includes an RRC release command; and
modifying a current operation from an RRC connected state to an RRC idle state or an RRC inactive state.

19. A method performed by a network entity, the method comprising:
transmitting, to a reader device, a first message comprising a configuration that identifies one or more preferences associated with operation of the reader device; and
receiving, from the reader device, a second message comprising one or more parameters associated with the identified one or more preferences.

20. The method of claim 19, further comprising:
transmitting, to the reader device, a third message that comprises a command to adjust the one or more parameters associated with the one or more preferences.
